(19) United States
(12) Patent Application Publication
(10) Pub. No.: US 2021/0192612 A1
(43) Pub. Date: Jun. 24, 2021

(54) PEER-TO-PEER LENDING PLATFORM BASED ON FINANCIAL HEALTH ANALYSIS

(71) Applicant: Wells Fargo Bank, N.A., San Francisco, CA (US)

(72) Inventors: Jennifer A. Fisher, Belmont, CA (US); Lynne Kenny, Walnut Creek, CA (US); Jesse F. Lee, Dublin, CA (US); Carola K. Neumann, San Francisco, CA (US)

(21) Appl. No.: 15/370,428

(22) Filed: Dec. 6, 2016

Related U.S. Application Data
(60) Provisional application No. 62/271,587, filed on Dec. 28, 2015.

(51) Int. Cl. G06Q 40/02; G06Q 40/00

(52) U.S. Cl. CPC G06Q 40/025; G06Q 40/12

(57) ABSTRACT

A computer-implemented method includes receiving loan requests, including a loan amount and loan attributes, from a plurality of borrowers. The method further includes managing a bank account for an account holder, including processing transactions for the bank account. The method further includes managing a lending account for the account holder. Managing the lending account includes: associating the bank account of the account holder with the lending account, receiving transaction history data from the bank account of the account holder, analyzing financial health (e.g., a loan capacity) of the account holder based on the transaction history data, identifying a loan request to the account holder based on the loan amount and loan attributes of the loan requests and the financial health of the account holder, receiving a selection of the loan request; and facilitating a loan between the account holder and the borrower of the loan request.

### CROSS-REFERENCE TO RELATED PATENT APPLICATIONS

This application claims priority from U.S. Provisional Application No. 62/271,587, entitled “PEER-TO-PEER LENDING PLATFORM BASED ON FINANCIAL HEALTH ANALYSIS”, filed Dec. 28, 2015, incorporated herein by reference in its entirety.

### TECHNICAL FIELD

Embodiments of the present disclosure relate generally to the field of online banking. In particular, they relate to facilitating peer-to-peer lending between lenders and borrowers via an online banking platform.

### BACKGROUND

An online banking application or platform may be used by a plurality of lenders and borrowers to facilitate peer-to-peer lending and peer-to-peer investing without going through a traditional financial intermediary such as a bank or other traditional financial institution. For example, a plurality of borrowers may provide loan requests to the online banking application, and a plurality of lenders may provide the loans to the borrowers. Lenders may select one or more loan requests and facilitate a loan with the respective borrowers of the loan requests. Lenders may fund the loans in whole or in part. For example, a plurality of lenders may combine, via the online banking application, to form a pool to collectively fund a loan.

### SUMMARY

A first exemplary embodiment relates to a computer-implemented method. The method includes receiving loan requests from a plurality of borrowers, each of the loan requests including a loan amount and loan attributes. The method further includes managing a bank account for an account holder, including processing transactions for the bank account, the transactions including at least one of checking transactions and credit card transactions. The method further includes managing a lending account for the account holder. Managing the lending account includes associating the bank account of the account holder with the lending account. Managing the lending account further includes receiving transaction history data from the bank account of the account holder. Managing the lending account further includes analyzing financial health of the account holder based on the transaction history data, wherein analyzing the financial health includes determining a loan capacity of the account holder. Managing the lending account further includes identifying at least one of the plurality of loan requests to the account holder based on each of the loan amount and the loan attributes of the respective loan requests, and the financial health of the account holder. Managing the lending account further includes receiving, from the account holder, a selection of one of the plurality of loan requests. Managing the lending account further includes facilitating a loan between the account holder and the borrower of the selected loan request.

Another exemplary embodiment relates to a system including a server system including a processor and instructions stored in non-transitory machine-readable media. The instructions are configured to cause the server system to receive loan requests from a plurality of borrowers, each of the loan requests including a loan amount and loan attributes. The instructions are further configured to cause the server system to manage a bank account for an account holder, including processing transactions for the bank account, the transactions including at least one of checking transactions and credit card transactions. The instructions are further configured to cause the server system to manage a lending account for the account holder. Managing the lending account includes associating the bank account of the account holder with the lending account. Managing the lending account further includes receiving transaction history data from the bank account of the account holder. The transaction history includes transactions from a plurality of different entities. Managing the lending account further includes identifying a topic of interest of the account holder based on the transaction history data. Managing the lending account further includes identifying at least one of the plurality of loan requests to the account holder based on each of the identified interests of the account holder and the loan attributes of the respective loan requests. Managing the lending account further includes receiving, from the account holder, a selection of one of the plurality of loan requests. Managing the lending account further includes facilitating a loan between the account holder and the borrower of the selected loan request.

A further exemplary embodiment relates to a system for facilitating peer-to-peer loans based on financial health. The system includes a data storage system. The system further includes a processor and program logic stored in memory and executed by the processor. The program logic includes a loan request circuit configured to receive loan requests from a plurality of borrowers, each of the loan requests including a loan amount and loan attributes. The program logic further includes a bank account management circuit configured to manage a bank account for an account holder, including processing transactions for the bank account, the transactions including at least one of checking transactions and credit card transactions. The program logic further includes a lending account management circuit configured to manage a lending account for the account holder, wherein managing the lending account includes associating a bank account of the account holder with the lending account, and receiving transaction history data from the bank account of the account holder. The program logic further includes a financial health circuit configured to analyze financial health of the account holder based on the transaction history data, wherein analyzing the financial health includes determining a loan capacity of the account holder. The program logic further includes a loan recommendation circuit configured to identify at least one of the plurality of loan requests to the account holder based on each of the loan amount and the loan attributes of each of the respective loan requests, and the financial health of the account holder. The program logic further includes a loan management circuit configured to receive a selection from the account holder of one of the plurality of loan requests, and to facilitate a loan between the account holder and the borrower of the selected loan request.

These and other features, together with the organization and manner of operation thereof, will become apparent from the following detailed description when taken in conjunction with the accompanying drawings.

### BRIEF DESCRIPTION OF THE DRAWINGS

FIG. 1 is a block diagram of a computing system, according to an exemplary embodiment.

FIG. 2 is a detailed block diagram of the lending circuit of the financial institution computing system of FIG. 1, according to an exemplary embodiment.

FIG. 3 illustrates an example process of facilitating a loan between a borrower and a plurality of lenders providing funds to the borrower, according to an exemplary embodiment.

FIG. 4 is a user interface showing loan details for a plurality of loan requests to a lender, according to an exemplary embodiment.

FIG. 5 is a flow chart of a process for facilitating peer-to-peer loans based on the financial health of a lender, according to an exemplary embodiment.

### DETAILED DESCRIPTION

Peer-to-peer loans are typically relatively small unsecured personal loans for various purposes, such as consolidating debt, funding large purchases, funding education, etc. Peer-to-peer lending platforms may include a large number of loan requests for relatively small value loans for many disparate purposes, which prospective lenders may choose to fund. Accordingly, prospective lenders may find it difficult to identify loan requests that are relevant to their personal financial and non-financial interests. In addition, some peer-to-peer loans may be more risky than conventional loans. For example, some peer-to-peer loans are requested by under-banked individuals that may not be able to secure a conventional loan from a financial institution. Accordingly, prospective lenders may find it difficult to evaluate risk levels and borrower characteristics of various loan requests.

Referring generally to the figures, systems and methods for a financial institution facilitating peer-to-peer lending between a borrower and one or more lenders are described. More particularly, systems and methods for facilitating lending between a borrower and one or more lenders based on a financial health analysis of a prospective lender are described. The lender may be a customer of the financial institution and may use the financial institution to facilitate one or more loans with one or more borrowers, who also may be customers of the financial institutions or may be independent users.

A financial institution can analyze a lender's financial data (e.g., assets, liabilities, transaction history, etc.) to assess the lender's financial health. The financial health may include, for example, an assessment of the lender's available funds after paying all recurring and typical liabilities per month. The financial institution may further determine personal non-financial interests of the lender based on past purchases, social media accounts, and other information relating to the activities of the lender. The financial institution then may determine areas in which the lender may be interested in investing, donating, or funding. The financial institution may present relevant lending opportunities to the lenders based on the lender's financial health and personal interests.

For the sake of clarity and brevity, embodiments are described herein as relating to peer-to-peer lending. However, embodiments described herein may similarly be utilized in connection with peer-to-peer investing. Peer-to-peer investing is the practice of investing money in notes to borrowers who are requesting a loan without going through a traditional financial intermediary and who are unknown to the investor. Investing may take place online via a peer-to-peer lending/investing platform. In some implementations, the notes can be sold as a security and so investors can exit the investment before the borrower repays the debt.

According to various exemplary embodiments, as described in further detail below, facilitating peer-to-peer lending based on financial health analysis of the lender improves the ability for a prospective lender to identify (e.g., recommend) peer-to-peer loan requests that are financially sound for the lender, as well as personally relevant to the lender. Unlike conventional peer-to-peer loan platforms, embodiments described herein tie in analysis of an individual's financial health (e.g., based on the individual's financial data) to a peer-to-peer loan platform to identify only those loan requests that are personally relevant to the individual. Further, the individual's financial health is also analyzed to provide recommended lending amounts so as to ensure that the lending opportunities are financially sound for the individual. Accordingly, embodiments described herein improve the ability and decrease the amount of time required for individuals to identify relevant and financially sound investments. Further, embodiments described herein enable both alternative loans and alternative investments that were not previously available for certain individuals.

In addition, exemplary embodiments described herein solve the technical and internet-centric problem of determining which of a plurality of loan requests to display to a particular individual via an internet-based peer-to-peer lending platform. This is addressed by leveraging an individual's financial data (e.g., transaction history data) to analyze the user's financial health to determine the individual's non-financial personal interests. Only those particular loan requests that are personally relevant and financially sound for the particular individual are displayed to the individual so that the individual may choose which peer-to-peer loans to fund. This provides a technical solution to the internet-centric challenge of providing an optimal, individualized internet-based peer-to-peer lending platform.

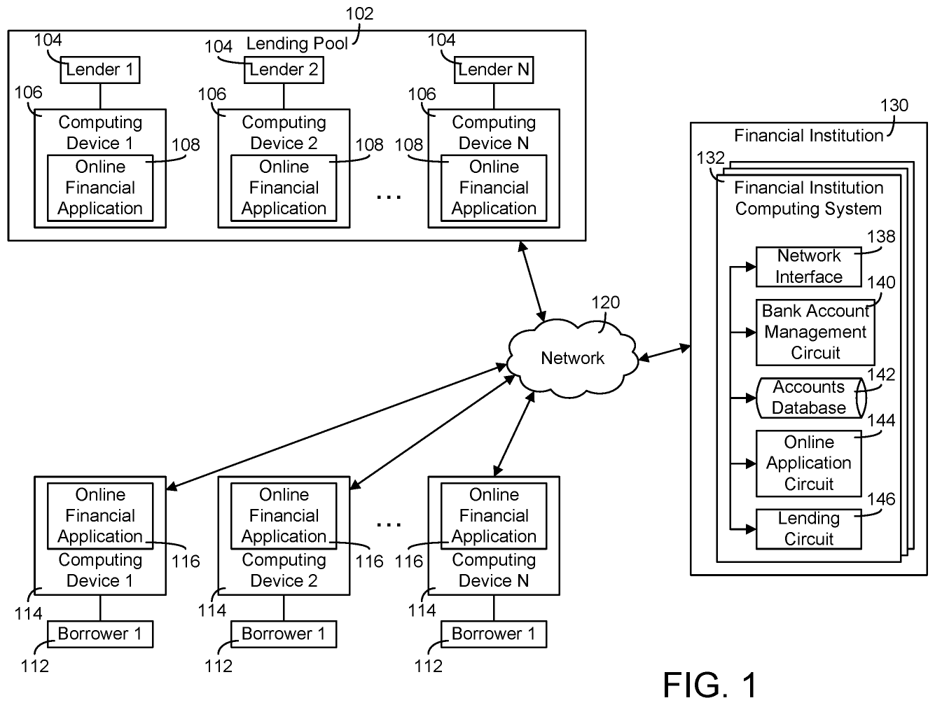

Referring to FIG. 1, a block diagram of a computing system 100 is shown, according to an exemplary embodiment. The computing system 100 may generally include a plurality of lenders 104, a plurality of borrowers 112, a network 120, and a financial institution computing system 132 associated with a financial institution 130. As will be appreciated, one or more of the plurality of lenders 104 may be associated with one or more lending pools 102. It should be understood that while FIG. 1 and the accompanying disclosure is primarily described with respect to a financial institution, lender, and borrower, such disclosure is for illustrative purposes only. In other embodiments, the systems and methods herein may be implemented for other types of institutions and users accessing a service of the institution.

The financial institution computing system 132 may be a computing system operated or held by a financial institution 130. In various embodiments, more than one financial institution may be included in the computing system 100 for providing lending management for various lenders 104 and borrowers 112. The financial institution computing system 132 may generally include a processor, one or more memory devices, a network interface 138, a bank account management circuit 140, an accounts database 142, an online application circuit 144, and a lending circuit 144. The processor may be implemented as a general-purpose processor, an application specific integrated circuit (ASIC), a digital signal processor (DSP), a group of processing components that may be distributed over a geographic region, or other suitable electronic processing components. The one or more memory devices (e.g., RAM, ROM, NVRAM, flash memory, hard disk storage, etc.) may store data and/or computer code for facilitating at least some of the various processes described herein. In this regard, the memory may store programming circuits that, when executed by the processor, control the operation of the financial institution computing system.

The network interface 138 may facilitate the sending and receiving of data, commands, instructions, values, etc. over the network 102 (e.g., to and from the computing devices 106, 114). The network interface 138 may be configured to facilitate the communications via a wired or wireless connection.

The bank account management circuit 140 is configured to manage a bank account for an account holder of the financial institution 130. The account holder may be a lender 104 or a borrower 112. The account holder may have any type of account with the financial institution 130 (e.g., an account for lending transactions only, a general account for a plurality of banking-related functions, etc.). For example, the account may be for a company or other large entity and the bank account management circuit 140 can be used for various large-scale banking needs, or the account may be for an individual and the bank account management circuit 140 can be used for personal banking needs.

The bank account management circuit 140 may process transactions such as checking transactions and credit card transactions for an account holder (e.g., a lender 104). As another example, the bank account management circuit 140 may process various payments to and from a lender 104 relating to a number of liabilities (e.g., mortgages, educational loans, home equity loans, etc.) and assets (e.g., investments, a demand deposit account, etc.). The bank account management circuit 140 may generally be configured to provide various banking-related features to the lender 104 that may or may not generally relate to lending activities of the account holder.

The accounts database 142 may generally store account information relating to accounts held by account holders of the financial institution 130, such as the lenders 104 and the borrowers 112. In some embodiments, more than one financial institution 130 with an associated financial institution system 132 may be communicably coupled to the components of FIG. 1 over the network 102 to accommodate several accounts held by a lender 104 or borrower 112 by two or more financial institutions. In some embodiments, the borrower 112 may not have an account with the financial institution 130, and the financial institution may facilitate a loan between the lender 104 and borrower 112 without the borrower 112 having an account.

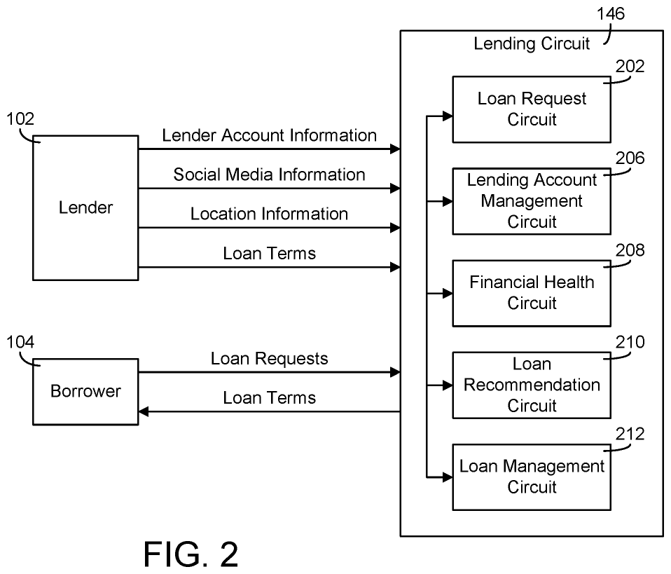

The account information stored by the accounts database 142 may include lender or borrower activity with the financial institution 130. For example, the account information may include previous loan information associated with a lender 104 or borrower 112 (e.g., previous loans provided by the lender to a borrower, the current status of a loan with a borrower, etc.). The account information may further include the financial health of the lender 104. For example, as described below, a lending circuit 144 may be configured to determine the lender's capability to provide a loan based on the lender's available funds, the lender's fees and monthly payments, and so on. The account information may further include one or more interests of the lender 104, indicating a possible area of interest for a future loan. Such account information is described in greater detail with reference to FIG. 2.

The account information stored by the accounts database 142 may further include borrower activity with the financial institution 130. For example, the account information may include, for a particular loan request, loan request attributes such as an amount of the loan, a purpose of the loan (e.g., starting a business, buying a house, etc.), demographics, and other borrower 112 information that may impact the decision by a lender 102 to select the loan request. In addition to storing loan account information for lenders 104 and borrowers 112, the accounts database 142 may further store account information for non-lending and non-borrowing accounts of the lenders 104 and borrowers 112 (i.e., storing account information for any type of banking activity with the financial institution 130).

The financial institution computing system 132 may further include an online application circuit 144 configured to manage a user interaction with the financial institution 130 and more particularly an application of the financial institution 130. The application may generally be used to facilitate a loan process with lenders 104 and borrowers 112 as described in the present disclosure. In various embodiments, the online application circuit 144 may provide an application for download at a computing device 106, 114, or may provide a web-based interface application accessible by a computing device 106, 114. The financial institution computing system 132 may further include any number of circuits for providing various others features to various users of the financial institution beyond the scope of the present disclosure.

The financial institution computing system 132 may include a lending circuit 146 for managing a lending process between a plurality of lenders 104 and borrowers 112. The lending circuit 146 may receive a plurality of loan requests from a plurality of borrowers 112 and provide a portion of the loan requests to a plurality of lenders 104. The lending circuit 146 may further receive a selection of a loan request from a lender 104 and facilitate a loan between the lender 104 and a borrower 112 based on the selection. The lending circuit 146 may be configured to use lender account information stored in lender account database 140 and borrower account database 142 (or information received directly from the lenders or borrowers) to determine which loan requests to provide to a particular lender, according to an exemplary embodiment. The activities of the lending circuit 146 are described in greater detail in FIG. 2.

A lender 104 may include any type of entity (e.g., a company, corporation, business, organization, government institution, any other group, an individual user) who may wish to provide loans to a one or more borrowers. The lender 104 may have an account with the financial institution 130 and facilitate a loan process with a borrower through the financial institution computing system 132. Individual loans may be facilitated by a single lender 104 or by a plurality of lenders 104 that together form a lending pool 102 to collectively fund a loan.

In some embodiments, various lenders 104 associated with the lending pool 102 may be distributed across multiple locations, or may be in a single location. It should be understood that the type of lender 104 facilitating a loan process with borrowers as described in the present disclosure is not limiting. In various embodiments, the environment of FIG. 1 may include any number of lenders 104 or lending pools 102.

In one embodiment, the borrower 112 may be an individual user requesting a loan (e.g., a loan related to a start-up business, a personal purchase such as a car or house, etc.) through the financial institution 130. In other embodiments, the borrower 112 may include any type of entity (e.g., a company, corporation, business, organization, government institution, any other group, an individual user, etc.) requesting a loan through the financial institution 130. In various embodiments, the borrower 112 may be represented by a single user (and associated computing device) or by multiple users and multiple computing devices, which may or may not be distributed across multiple locations. It should be understood that the type of borrower 112 engaged in a loan process with lenders as described in the present disclosure is not limiting.

Each lender 104 or borrower 112 may access an application of the financial institution 130 via a computing device 106, 114 and more particularly an online financial application 108, 116 of the computing device 106, 114. The computing device 106, 114 may be, for example, a mobile device. A mobile device may include, for example, a phone (e.g., smartphone), a computing device such as a tablet, laptop, or PDA, a wearable device (e.g., a smart watch, smart bracelet, smart glasses, etc.), or otherwise. As another example, the computing device 106, 114 may be any type of electronic device such as a desktop.

The online financial application 108, 116 may be downloaded by the computing device 106, 114 prior to its usage, may be hard coded into the memory of the computing device 106, 114 or may be a web-based interface application such that the computing device 106, 114 may provide a web browser (or other client interface) to the application, which may be executed and maintained remotely. In the latter instance, the user may have to log onto or access the web-based interface before usage of the applications. Further, and in this regard, the online financial application 108, 116 may be supported by a separate computing system including one or more servers, processors, network interface circuits, etc. that transmit the applications for use to the computing device 106, 114. In certain embodiments, the online financial application 108, 116 may include an application programming interface (API) and/or a software development kit (SDK) that facilitate the integration of other applications with the online financial application 108, 116. In another embodiment, the online financial application 108, 116 could be provided as a single application.

Referring now to FIG. 2, the lending circuit 146 of the financial institution computing system 132 is shown in greater detail. As described above, the lending circuit 146 may generally facilitate a peer-to-peer loan process between a lender 104 and a borrower 112. The lending circuit may generally receive a plurality of loan requests from borrowers 112 and determine which loan requests to present to lenders 104 based on lender information.

The lending circuit 146 is shown to include a loan request circuit 202. The loan request circuit 202 is configured to receive a plurality of loan requests from a plurality of borrowers 112. The loan requests may generally include a loan amount and loan attributes. The loan attributes may include, for example, an area of interest of the borrower requesting the loan, details relating to the usage of the money to be provided in the loan, financial details impacting a transaction to be completed between the borrower and a lender, and any other information that may be relevant to a lender when determining whether to facilitate a loan with the borrower.

In some embodiments, a borrower 112 providing a loan request may be a customer of the financial institution 130, and the loan attributes may include account information for the borrower. In other embodiments, a borrower 112 providing a loan request may not be a customer of the financial institution 130. The financial institution 130 may still be configured to facilitate a loan between the borrower 112 and a lender. The loan request circuit 202 may be configured to validate the borrower 112 (e.g., to determine that the borrower is a legitimate entity or user requesting the loan). The loan request circuit 202 may determine a rating, ranking, or other metric that can be used to determine if the borrower is a legitimate entity or user.

The loan requests, including the loan amount and loan attributes, may be stored in a borrower account database 142. The loan request circuit 202 may further be configured to manage one or more loan requests stored in the borrower account database 142 (e.g., to remove old requests, to update loan requests based on a new status of the borrower, and the like).

The lending circuit 146 further includes a lending account management circuit 206. The lending account management circuit 206 is configured to manage a lending account of the lender 104. In some embodiments, the lending account management circuit 206 may associate a financial account of the lender 104 with the lending account of the lender 104, the financial account being separate from the lending account (i.e., the financial account is not used for lending activity). The financial account associated with the lending account may not be used by the lender to execute various transactions relating to one or more loans the lender 104 is providing to one or more borrowers 112. The financial account may be, for example, a credit card, demand deposit, brokerage account, any other type of account, or any combination therein. The lending account management circuit 206 may further be configured to manage a lending account of the lender 104. The lending account management circuit 206 may manage lending account information, such as a tax history of the lending account, previous loan history, etc.

The lending circuit 146 further includes a financial health circuit 208. The financial health circuit 208 is configured to analyze the financial health of the lender 104. In some embodiments, the financial health of the lender 104 may be determined based on the transaction history data of the lender, account information of the lender, etc. For example, referring also to bank account management circuit 140 and lending account management circuit 206, a transaction history, a bank account, and other information for the lender 104 may be analyzed. Transactions executed by the lender 104 may be analyzed to determine a financial obligation of the lender (e.g., a weekly, monthly, or yearly payment for one or more services, one or more loans for which the lender is responsible for, etc.). Historical account balances and variability in expenses of the lender 104 may be analyzed to determine the funds the lender typically has on hand. Income (e.g., direct deposits) may be analyzed to determine the ability of the lender 104 to maintain or grow his or her assets. All such information may be used to determine a “cushion”, i.e., an excess amount of money that the lender 104 can use for lending or funding opportunities (e.g., for a peer-to-peer loan as described in the present disclosure).

The financial health of the lender 104 as determined by the financial health circuit 208 may include a loan capacity of the lender (e.g., a maximum amount that the lender is capable of loaning to a borrower). The loan capacity may indicate a total amount or a monthly or weekly amount (e.g., an amount per month or week that the lender is capable of providing for a loan), and may further include various parameters such as when the lender is capable of making the payment (e.g., first of month, last of month, more or less in a given time period, etc.).

In one embodiment, the financial health circuit 208 may also be configured to analyze the financial health of a borrower 112 submitting a loan request to the financial institution 130. In one embodiment, the borrower 112 may have an account with the financial institution 130, which may be used to determine the financial health of the borrower. For example, the financial health circuit 208 may analyze the account of the borrower 112 to determine if the borrower 112 is capable of paying back loans to a lender 104, if the borrower 112 is a responsible consumer, etc. In another embodiment, the financial health circuit 208 may retrieve a credit score (e.g., a FICO score) or other metric that represents the financial activity of the borrower 112, and use the credit score to determine the financial health of the borrower 112. The financial health of the borrower 112 may then be used to determine if the loan request made by the borrower 112 is presentable to lenders 104 or not (e.g., a lender 104 may or may not have a minimum threshold for financial health for a borrower in order to be presented with a loan request from the borrower).

In some embodiments, the financial health of a lender 104 may indicate that a lender 104 might not be able to provide a full loan for a particular loan request, but may be able to provide a partial loan for a loan request. For example, for a loan request of $50,000, a lender 104 may only be able to afford providing $10,000 for the loan. The financial health circuit 208 may identify a situation in which the lender 104 is unable to provide a full loan but may be able to provide a partial loan.

The lending circuit 146 further includes a loan recommendation circuit 210. The loan recommendation circuit 210 is configured to provide at least one of the plurality of loan requests (received at loan request circuit 202) to the lender 104, via an online application as described with reference to FIG. 1. The one or more loan requests provided to the lender 104 may be chosen based on the loan amount and loan attributes of the loan requests. For example, based on the loan amount, the lender 104 may be provided with loan requests that the lender can afford based on the financial health of the lender (as determined by the financial health circuit 208).

The loan attributes may be used to determine whether to provide a lender 104 with a particular loan request. In some embodiments, the loan recommendation circuit 210 may determine one or more personal interests of the lender 104, and may determine if the personal interests match the loan attributes. The lending circuit 146 may receive non-financial institution data from the lender 104 and use the non-financial institution data to determine the one or more interests of the lender 104.

As one example, the lending circuit 146 may receive social media information from the lender 104 (e.g., Twitter account information, Facebook account information, etc.) and use the social media information to determine personal interests. For example, if the lender 104 has several social media posts relating to an event, the loan recommendation circuit 210 may determine a lender's interest in the event. As another example, if the lender 104 leaves a comment or “likes” a particular social media page, the loan recommendation circuit 210 may determine an interest relating to the subject of the social media page.

As an example of non-financial institution data, the lending circuit 146 may receive location data of the lender 104. The location data may include where the lender 104 is located or based. The location data may be used to provide the lender 104 with lending opportunities from borrowers that are local to the lender, or to causes and events that are local to the lender. This may allow the lender 104 to provide loans for projects that are local to the lender and therefore may be of greater interest.

As another example of non-financial institution data, the lending circuit 146 may receive a purchase history or other such financial data of the lender 104 (such information may also be retrieved from a bank account management circuit 140). The purchase history may generally relate to a plurality of financial transactions in which the lender 104 has participated, such as a plurality of purchases made by the lender. The purchase history may indicate an area of interest of the lender 104 as the lender has been shown to spend money on the area of interest. The area of interest may then be used to identify loan requests that are related to the area of interest of the lender 104. As one example, the lender 104 may often make purchases at a particular store or particular type of store (e.g., a particular restaurant or type of restaurant). For instance, completing transactions at a sporting goods store and buying tickets for a sporting event may allow the loan recommendation circuit 210 to determine that the lender 104 may be interested in a loan relating to a sports-related startup company. The loan recommendation circuit 210 may be configured to track purchase history to determine if the lender 104 has any spending trends that can be identified, and may use any threshold for determining an area of interest of the lender (e.g., the lender 104 visiting a store a minimum number of times in a month or a year, the lender 104 completing a minimum number of transactions in a month or year, etc.).

As another example, other personal information (e.g., gender, ethnicity, education background, age, etc.) may be used to determine an area of interest of the lender 104. For example, a college or university the lender 104 attended may be identified, which may be used to suggest loan requests originating from a borrower 112 that attended the same college or university, or loan requests that specifically relate to the college or university. As another example, gender, ethnicity, or age may be used to identify loan requests that are tailored to be advantageous to a particular group of people.

As another example, one or more organizations or other groups the lender belongs to may be used to determine an area of interest of the lender 104. For example, if the lender 104 is religious, loan requests relating to a particular religion may be identified as possibly relevant to the lender 104. As another example, if the lender 104 belongs to a group participating in a particular hobby, the lender 104 may be presented with lending opportunities relating to the hobby. As yet another example, if the lender 104 contributes to one or more charities, the beneficiaries of the charities may be identified to determine the area of interest of the lender 104.

The non-financial institution data may be provided to the lending circuit manually by the lender 104. This data may be shared by the lender 104 via the lender's approval. In various embodiments, the lender 104 may choose which personal information to provide to the lending circuit 146.

In some embodiments, previous loan information may be used by the loan recommendation circuit 210 to determine an interest of the lender 104. For example, if the lender 104 has previously provided a loan to a borrower 112 for a particular cause, the lender 104 may consider providing a loan for a similar cause in the future. The loan recommendation circuit 210 may be configured to analyze previous loan information to determine one or more areas of interest that the lender 104 is more likely to provide a loan for in the future.

As described above, the loan requests may be provided to the lender 104 via an online application, using any type of interface. The information provided with the loan requests may generally include the borrower, the loan amount and loan attributes, and other detailed information that allows the lender 104 to make an informed decision. In some embodiments, the lender 104 may be presented with information about how the loan requests were selected. For example, if a loan request was provided because of a lender 104 interest identified by the loan recommendation circuit 210, the lender 104 may be informed of such a selection. In some embodiments, the lender 104 may be presented with information relating to the impact of selecting a loan request. For example, an impact on the available funds of the lender 104 by selecting the loan request may be provided, as well as an impact on the available funds of the borrower 112 (i.e., showing how receiving the funds will impact the activities of the borrower).

As generally described in the present disclosure, multiple lenders 104 may provide funds for a single loan request from a borrower 112. In such an embodiment, the loan recommendation circuit 210 may be configured to provide loan requests to a plurality of lenders 104 even if the lenders cannot individually afford to provide a full loan for the loan request. In other words, the loan recommendation circuit 210 may facilitate partial loans, allowing a single loan request to be fulfilled by more than one lender 104, that together form the lending pool 102. The loan recommendation circuit 210 may be configured to provide a suggestion for a partial loan amount to each lender 104 of the lending pool 102. For example, the loan recommendation circuit 210 may identify (e.g., recommend) a specific amount based on the expected available funds of the lender, the total loan amount, and an expected or predicted amount of the loan that may be covered by other lenders of the lending pool 102.

The lending circuit 146 further includes a loan management circuit 212. The loan management circuit 212 may generally manage a loan approval process between lenders 104 and a borrower 112. The loan management circuit 212 is configured to receive a selection of a loan request from a lender 104 (provided to the lender by loan recommendation circuit 210). The loan management circuit 212 may then verify the selection of the loan request for both the lender 104 and borrower 112, and provide various loan management features throughout the loan process (e.g., facilitating payments between the lender 104 and borrower 112).

In some embodiments, the loan management circuit 212 may receive loan terms from the lender 104. Upon selection of a loan request, a lender 104 may provide loan terms for the loan to the borrower 112 through the lending circuit 146. The loan terms may generally include, for example, a payment plan for the borrower 112 to pay back the lender 104 (if a payback is required for the loan) and interest rates for the loan. The loan terms may further include, for example, how a loan is to be paid back, how the borrower 112 should spend the funds (e.g., restricting or allowing certain purchases), if the lender 104 should receive any return on investment, and the like. The loan management circuit 212 may generally be configured to handle such activity so that the lender 104 does not directly have to receive payments from the borrower 112. The loan terms may be approved by the lender 104 and borrower 112 before initiating the loan request.

As described above, multiple lenders may provide funds for an individual loan. The loan management circuit 212 may generally be configured to manage a process for facilitating a loan between multiple lenders and a borrower. For example, the loan management circuit 212 may indicate to a lender the status of a particular loan request (e.g., a loan request is already 50% funded by other lenders, a loan request does not have any lenders so far, etc.). The loan management circuit 212 may be configured to allow a lender to specify how much he or she wishes to provide out of the remaining total needed for the loan. The loan management circuit 212 may be configured to notify all lenders when a loan request is fully funded, when a loan request fails to meet its total and is canceled, and may generally provide other such management-related features when a loan request is to be funded by multiple lenders.

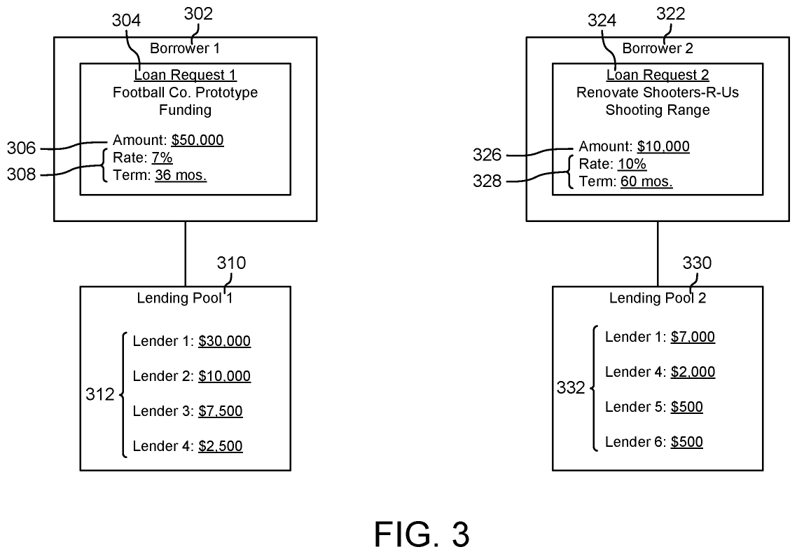

Referring also to FIG. 3, a loan process facilitated between a borrower and a plurality of lenders is illustrated in greater detail. A first borrower 302 may submit a first loan request 304. The loan request 304 submitted by the borrower 302 includes a loan amount 306 and loan attributes 308 (e.g., an interest rate and a term for paying back the loan to the lenders). The loan request 304 may include other information, such as a title or other description of the loan (e.g., “Football Co. Prototype Funding”). This description may be used by the lending circuit 146 to match potential lenders of interest to the loan request. For example, using the description, the loan recommendation circuit 210 may match lenders who have shown an interest in football to the loan request, and create a lending pool 310 of potential interested lenders.

A subset of the lenders in the lending pool 310 may choose to accept the loan request 304 and agree to fund (or partially fund) the loan. As shown in FIG. 3, four different lenders 312 are shown to accept the loan request 304. Each lender 312 is shown to partially fund the loan (e.g., a first lender provides $30,000 of the $50,000 loan, and so forth). Each lender 312 may specify how much he or she is willing to provide for the loan, and a loan management circuit 212 may be configured to manage a process of allowing multiple lenders to provide funds for a single loan request.

A second loan request 324 from a second borrower 322, with a loan amount 326 and loan attributes 328, is illustrated in FIG. 3. Each loan request provided may result in a different lending pool 330 created, including different lenders who may have different interests and financial capabilities. A plurality of lenders 332 are shown to fund the loan request 324. In some embodiments, a single lender (e.g., “Lender 1” and “Lender 4”) may provide funds for multiple loan requests simultaneously. Lenders may be capable of providing funds for more than one loan request, and may be placed in more than one lending pool for a particular loan request or set of loan requests.

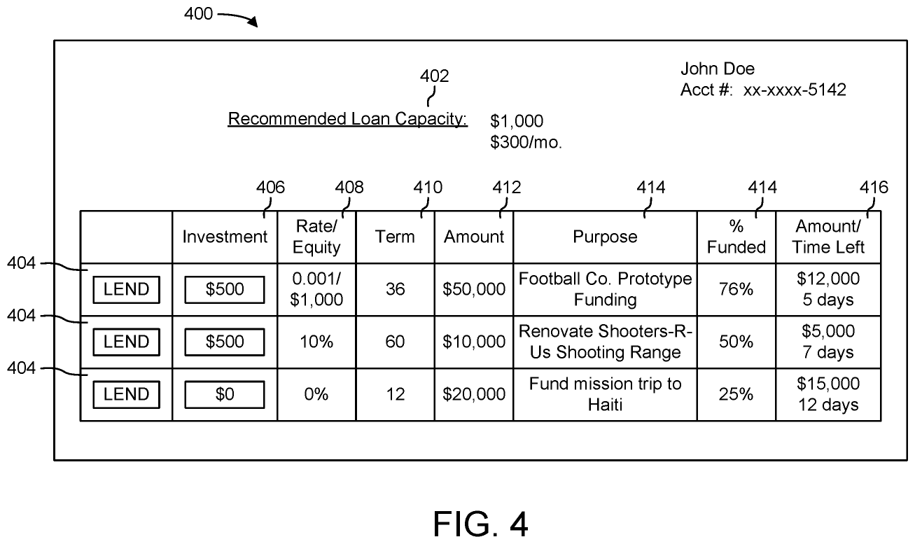

Referring now to FIG. 4, an example user interface 400 showing loan details for a plurality of loan requests to a lender is shown, according to an exemplary embodiment. The user interface 400 is an example user interface that can be presented to a lender 104 via the loan recommendation circuit 210, for example. The user interface 400 may allow a lender to select one or more loan requests for which to provide funds. In various embodiments, the loan requests may be ranked based on a combination of any/all of the factors described above in connection with FIG. 2, and the lender may be provided with a ranked listing of the loan requests based on, e.g., predicted interest of the lender in each of the loan requests.

The user interface 400 may display a recommended loan capacity 402. The recommended loan capacity 402 may be a maximum amount that the lender may be allowed to provide for loans. For example, the recommended loan capacity 402 may be determined by the financial health circuit 208. The recommended loan capacity 402 may be a total amount that the lender is recommended to provide (e.g., $1,000 total) or a total monthly or weekly amount (e.g., the lender is not recommended to provide more than $300 a month for a loan). The recommended loan capacity 402 may be a firm threshold or may just be a suggested total for the lender. In any event, the recommended loan capacity 402 is an amount that the financial health circuit 208 determines that the lender 104 may provide without compromising his or her financial health.

For a given loan request 404, the user interface 400 may display various information relating to the loan. For example, the user interface 400 may display an investment amount 406 and a total amount 412. In some embodiments, the lender may choose to fully fund a loan request or partially fund a loan request. As shown in FIG. 4, the lender may choose to provide $500 towards a $50,000 loan amount 412. The user interface 400 may provide a suggested amount to the lender in the investment amount 406 column, and/or the lender may enter a desired amount in the column.

For a given loan request 404, the user interface 400 may further provide a rate column 408 and term column 410 specifying the rate and term for loan payments from a borrower of the loan request. The rate and term define how the borrower will pay back the lender for the loan. The user interface 400 may further include a purpose column 412 generally identifying the cause or activity associated with the loan request.

The user interface 400 may include a funded column 414 indicating the current status of a loan request. As described above, in some embodiments, a particular loan request may be funded by a plurality of lenders. The funded column 414 may indicate a current status of the loan request (e.g., a percentage of the loan amount that is funded so far, how many lenders have funded the loan request so far, etc.). The user interface 400 may further include a status column 416 indicating a total amount funded so far and an amount of time left. In some embodiments, a loan request may include a time limit (e.g., a time by which the loan request must be funded). The status column 416 may identify to the lender various loan request status information that may impact the decision by the lender to fund the loan request or not.

In some embodiments, instead of a borrower paying interest to a lender for the loan, the lender may receive other considerations from the borrower. For example, the lender may receive a partial equity share. In various embodiments, the lender and borrower may negotiate such terms with each other. Referring to the user interface 400 of FIG. 4, a loan request is shown as including 0.001% equity interest per $1,000 contribution as consideration for funding the loan request.

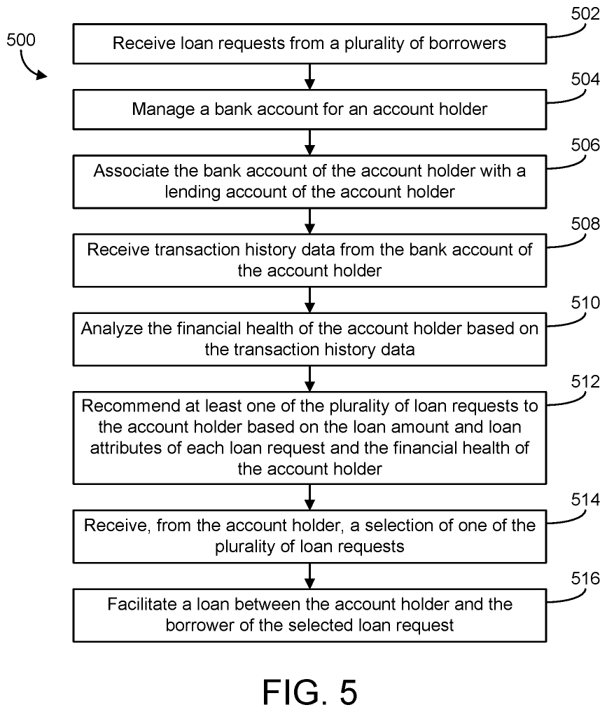

Referring now to FIG. 5, a flow chart of a process 500 for facilitating peer-to-peer loans based on the financial health of a lender is shown, according to an exemplary embodiment. The process 500 may be executed by, for example, the lending circuit 146 of FIG. 2.

The process 500 includes receiving loan requests from a plurality of borrowers (502). Each loan request from a borrower may include a loan amount and loan attributes. The loan attributes may generally include, for example, an area of interest of the borrower requesting the loan, details relating to the usage of the money to be provided in the loan, financial details impacting a transaction to be completed between the borrower and a lender, and any other information that may be relevant to a lender when determining whether to facilitate a loan with the borrower.

The process 500 further includes managing a bank account for an account holder (504). The account holder may be, for example, a lender. Managing the bank account may generally include processing transactions for the account holder such as checking transactions and credit card transactions. Managing the banks account may further include processing various payments to and from the account holder relating to a number of liabilities (e.g., loans, bills, etc.) and assets (e.g., investments).

The process 500 further includes associating the bank account of the account holder with a lending account of the account holder (506). As described above, the account holder may be a lender, and block 506 includes associating the bank account of the account holder with lending activities of the account holder. In some embodiments, the bank account may be a financial account of the account holder that is separate from the lending account. The bank account may, for example, a credit card, demand deposit, brokerage account, any other type of account, or any combination therein.

The process 500 further includes receiving transaction history data from the bank account of the account holder (508) and analyzing the financial health of the account holder based on the transaction history data (510). Transaction history data may be received from the account holder, or may be determined while managing the bank account of the account holder at block 504.

Analyzing the financial health of the account holder block 510 may include using the transaction history data. Analyzing the financial health may generally include, for example, determining a financial obligation of the lender (e.g., a weekly, monthly, or yearly payment for one or more services, one or more loans for which the lender is responsible for, etc.). Historical account balances and variability in expenses of the lender may be analyzed to determine the funds the lender typically has on hand. Income (e.g., direct deposits) may be analyzed to determine the ability of the lender to maintain or grow his or her assets.

The process 500 further includes identifying at least one of the plurality of loan requests to the account holder based on the loan amount and loan attributes of each loan request and the financial health of the account holder (512). For example, one or more loan requests may be provided to the account holder based on if the loan amount of the loan request is within the loan capacity (as determined by the financial health) of the account holder.

In some embodiments, block 512 includes selecting one or more loan requests to be provided to the account holder based on a topic of interest of the account holder. Block 512 may include analyzing the transaction history data received at block 508 and determining attributes of the transactions (e.g., if the account holder purchased an item at the store, the type of store may be marked as an attribute). If the attributes match or closely match the loan attribute of the loan request, the loan request may then be provided to the account holder. This may allow the account holder to view loan requests that may be related to the interests of the account holder.

In some embodiments, block 512 includes associating a social media account of the account holder with the lending account of the account holder. Social media activity data may then be received from the social media account and used to determine a topic of interest of the account holder. If the topic of interests closely matches a loan attribute of the loan request, the loan request may then be provided to the account holder.

The process 500 further includes receiving, from the account holder, a selection of one of the plurality of loan requests (514) and facilitating a loan between the account holder and the borrower of the selected loan request (516). In some embodiments, block 516 may include receiving loan terms from the account holder, which may be used to facilitate the loan between the account holder and borrower. The loan terms may generally include a payment plan for the borrower to pay back the account holder, a method of payment, how the loan funds should be spent by the borrower, etc. The loan terms may be provided to the borrower, and block 316 may include receiving approval of the loan terms from the borrower prior to facilitating the loan between the account holder and borrower.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A computer-implemented method performed by a server system having a processor and non-transitory computer-readable media, the method comprising:
receiving, by the server system, loan requests from a plurality of borrowers, each of the loan requests including a loan amount and loan attributes;
managing, by the server system, a bank account held by an account holder with a financial institution associated with the server system, including processing transactions for the bank account, the transactions including at least one of checking transactions or credit card transactions; and
managing, by the server system, a lending account for the account holder, the lending account held by the account holder with the financial institution, wherein managing the lending account includes:
associating, by the server system, the bank account of the account holder with the lending account,
associating, by the server system, a social media account of the account holder with the lending account,
receiving, by the server system, transaction history data from the bank account of the account holder, wherein the transaction history data includes a purchase history and recurring liabilities,
receiving, by the server system, social media activity data from the social media account of the account holder, wherein the social media activity data includes interactions with a social media page,
receiving, by the server system based on a wireless connection with a user device, location data of the account holder indicative of where the account holder is located,
analyzing, by the server system, financial health of the account holder based on the transaction history data, including the recurring liabilities, historical account balances, and variability in expenses of the account holder, wherein analyzing the financial health includes determining a loan capacity of the account holder, the loan capacity comprising money available to the account holder for making one or more loans on a one-time, weekly, or monthly basis in excess of an amount of funds needed to cover at least the recurring liabilities,
analyzing, by the server system, the purchase history of the account holder to determine purchase attributes, wherein the purchase attributes include a category of store where a purchase was completed,
tracking, by the server system, a personal interest of the account holder based on the purchase attributes and the social media activity data to determine the personal interest of the account holder, wherein the purchase history includes a number of purchases above a determined threshold with a particular purchase attribute,
identifying, by the server system, a subset of the plurality of loan requests based on the personal interest of the account holder, the loan attributes of the loan requests, and the location of the account holder,
matching, by the server system, at least one of the subset of the plurality of loan requests to the account holder based on the loan amount of the respective loan requests, and further based on the determined loan capacity of the account holder on the one-time, weekly, or monthly basis,
transmitting, by the server system, the at least one of the subset of the loan requests to the account holder including the borrower, the loan amount, the loan attributes, and information regarding how the at least one of the subset of the loan requests were selected, wherein the information regarding how the at least one of the subset of the loan requests were selected include at least one of the personal interest of the account holder, the loan amount, and a location of the borrower,
receiving, by the server system, from the account holder, a selection of one loan request from among the at least one of the subset of loan requests; and
facilitating, by the server system, a loan between the account holder and the borrower of the selected loan request.

2. (canceled)

3. (canceled)

4. The method of claim 1, wherein the loan amount of each respective loan request the at least one of the subset of the loan requests identified to the account holder are within the loan capacity of the account holder.

5. The method of claim 1,
wherein managing the lending account for the account holder further includes receiving, by the server system from the account holder, loan terms, and
wherein the loan between the account holder and the borrower is facilitated via the loan terms.

6. The method of claim 5, further comprising:
upon receiving the loan terms, proposing, by the server system, the loan terms to the borrower of the selected loan request; and
receiving, by the server system, approval of the loan terms from the borrower prior to facilitating the loan between the account holder and the borrower.

7. The method of claim 1, wherein managing the lending account for the account holder further includes associating, by the server system, a financial account of the account holder with the lending account, the financial account being separate from the bank account, wherein the financial health of the account holder is further based on transaction history data received from the financial account of the account holder, and wherein the financial account includes at least one of a credit card, demand deposit, and brokerage account.

8. A system, comprising:
a server system including a processor and instructions stored in non-transitory machine-readable media, the instructions configured to cause the server system to:
receive loan requests from a plurality of borrowers, each of the loan requests including a loan amount and loan attributes;
manage a bank account held by an account holder with a financial institution associated with the server system, including processing transactions for the bank account, the transactions including at least one of checking transactions or credit card transactions; and
manage a lending account for the account holder, the lending account held by the account holder with the financial institution, wherein managing the lending account includes:
associating the bank account of the account holder with the lending account,
associating a social media account of the account holder with the lending account,
receiving transaction history data from the bank account of the account holder, the transaction history data including transactions from a plurality of different entities, wherein the transaction history data includes a purchase history and recurring liabilities,
receiving social media activity data from the social media account of the account holder, wherein the social media activity data includes interactions with a social media page,
receiving, based on a wireless connection with a user device, location data of the account holder indicative of where the account holder is located,
analyzing financial health of the account holder based on the transaction history data, including the recurring liabilities, historical account balances, and variability in expenses of the account holder, wherein analyzing the financial health includes determining a loan capacity of the account holder, the loan capacity comprising money available to the account holder for making one or more loans on a single, weekly, or monthly basis,
analyzing the purchase history of the account holder to determine purchase attributes, wherein the purchase attributes include a category of store where a purchase was completed,
tracking a personal interest of the account holder based on the purchase attributes and the social media activity data to determine the personal interest of the account holder, wherein the purchase history includes a number of purchases above a determined threshold with a particular purchase attribute,
identifying a subset of loan requests based on the personal interest of the account holder, the loan attributes of the loan requests, and the location of the account holder,
matching at least one of the subset of the loan requests to the account holder based on the loan amount of the respective loan requests and the determined loan capacity of the account holder on a one-time, weekly, or monthly basis in excess of an amount of funds needed to cover at least the recurring liabilities,
transmitting at least one of the subset of the plurality of the loan requests to the account holder including the borrower, the loan amount, the loan attributes, and information regarding how the at least one of the subset of the loan requests were selected, wherein the information regarding how the at least one of the subset of the loan requests were selected include at least one of the personal interest of the account holder, the loan amount, and a location of the borrower,
receiving, from the account holder, a selection of one loan request from among the at least one of the subset of loan requests; and
facilitating a loan between the account holder and the borrower of the selected loan request.

9. (canceled)

10. (canceled)

11. The system of claim 8, wherein the loan amount of each respective loan request of the at least one of the subset of loan requests identified to the account holder are within the loan capacity of the account holder.

12. The system of claim 8,
wherein managing the lending account for the account holder further includes receiving, from the account holder, loan terms, and
wherein the loan between the account holder and the borrower is facilitated via the loan terms.

13. The system of claim 12, further comprising,
upon receiving the loan terms, proposing the loan terms to the borrower of the selected loan request, and
receiving approval of the loan terms from the borrower prior to facilitating the loan between the account holder and the borrower.

14. The system of claim 8, wherein managing the lending account for the account holder further includes associating a financial account of the account holder with the lending account, the financial account being separate from the bank account, wherein the financial health of the account holder is further based on transaction history data received from the financial account of the account holder, and wherein the financial account includes at least one of a credit card, demand deposit, and brokerage account.

15. A system for facilitating peer-to-peer loans based on financial health, the system comprising:
a data storage system; and
a processor and program logic stored in memory and executed by the processor, the program logic including:
a loan request circuit configured to receive loan requests from a plurality of borrowers, each of the loan requests including a loan amount and loan attributes;
a bank account management circuit configured to manage a bank account held by an account holder with a financial institution associated with the system for facilitating peer-to-peer loans, including processing transactions for the bank account, the transactions including at least one of checking transactions or credit card transactions;
a lending account management circuit configured to manage a lending account for the account holder, the lending account held by the account holder with the financial institution, wherein managing the lending account includes associating the bank account of the account holder with the lending account and receiving transaction history data from the bank account of the account holder, wherein the transaction history data includes a purchase history and recurring liabilities, managing the lending account further includes associating a social media account of the account holder with the lending account and receiving social media activity data from the social media account of the account holder, wherein the social media activity data includes interactions with a social media page, and receiving, based on a wireless connection with a user device, location data of the account holder indicative of where the account holder is located;
a financial health circuit configured to analyze financial health of the account holder based on the transaction history data, including the recurring liabilities, historical account balances, and variability in expenses of the account holder, wherein analyzing the financial health includes determining a loan capacity of the account holder, the loan capacity comprising money available to the account holder for making one or more loans on a one-time, weekly, or monthly basis in excess of an amount of funds needed to cover at least the recurring liabilities;
a loan recommendation circuit configured to:
analyze the purchase history of the account holder to determine purchase attributes, wherein the purchase attributes include a category of store where a purchase was completed,
track a personal interest of the account holder based on the purchase attributes and the social media activity data to determine the personal interest of the account holder, wherein the purchase history includes a number of purchases above a determined threshold with a particular purchase attribute,
identify a subset of the loan requests based on the personal interest of the account holder, the loan attributes of the loan requests, and the location of the account holder, and
match at least one of the subset of the loan requests to the account holder based on the loan amount of each of the respective loan requests, and further based on the determined loan capacity of the account holder on the one-time, weekly, or monthly basis;
an online application circuit configured to transmit the at least one of the subset of the loan requests to the account holder including the borrower, the loan amount, the loan attributes, and information regarding how the at least one of the subset of the loan requests were selected, wherein the information regarding how the at least one of the subset of the loan requests were selected include at least one of the personal interest of the account holder, the loan amount, and a location of the borrower; and
a loan management circuit configured to receive a selection from the account holder of one loan request of the at least one of the subset of the loan requests, and to facilitate a loan between the account holder and the borrower of the selected loan request.

16. (canceled)

17. (canceled)

18. The system of claim 15, wherein the loan amount of each respective loan request of the at least one of the subset of the loan requests identified to the account holder are within the loan capacity of the account holder.

19. The system of claim 15, wherein the lending account management circuit is further configured to receive, from the account holder, loan terms, wherein the loan between the account holder and the borrower is facilitated via the loan terms.

20. The system of claim 19, wherein the loan management circuit is further configured to:
upon receiving the loan terms, propose the loan terms to the borrower of the selected loan request, and
receive approval of the loan terms from the borrower prior to facilitating the loan between the account holder and the borrower.

21. The system of claim 15, wherein the lending account management circuit is further configured to associate a financial account of the account holder with the lending account, the financial account being separate from the bank account, wherein the financial health of the account holder is further based on transaction history data received from the financial account of the account holder, and wherein the financial account includes at least one of a credit card, demand deposit, and brokerage account.
